(19) United States
(12) Patent Application Publication
(10) Pub. No.: US 2019/0173595 A1
(43) Pub. Date: Jun. 6, 2019

(54) METHOD OF BROADCASTING A LIVE PERFORMANCE

(71) Applicant: Jason SIEBEN, Edmonton (CA)

(72) Inventor: Jason SIEBEN, Edmonton (CA)

(21) Appl. No.: 16/194,519

(22) Filed: Nov. 19, 2018

(30) Foreign Application Priority Data
Dec. 4, 2017 (CA) 2 987 603

(51) Int. Cl. H04H 60/42; H04H 60/23; H04H 60/58

(52) U.S. Cl. CPC H04H 60/42; H04H 60/58; H04H 60/23

(57) ABSTRACT

A method of broadcasting a live performance is provided. A back end gateway with set up functions for a broadcaster allows a broadcaster to set up a live broadcast. A live broadcasting signal is sent to the back end gateway. A front end gateway allows a user to connect to the live broadcast. The live broadcasting signal is sent from the back end gateway to the front end gateway. Users are provided access to the front end gateway to allow them to access the live broadcasting signal.

### FIELD OF THE DISCLOSURE

The present application relates generally to a method of broadcasting a live performance. More specifically, it related to a method of broadcasting a live performance in a predetermined radius.

### BACKGROUND

This section provides background information to facilitate a better understanding of the various aspects of the invention. It should be understood that the statements in this section of this document are to be read in this light, and not as admissions of prior art.

During sporting events and other live performances, it is often difficult to hear broadcasters and performers due to the loud crowds in attendance. While watching the sporting event or other live performance, attendees often miss out on the play by play and other valuable information provided by broadcasters. It is difficult to access broadcasts that provide play by play that corresponds to the sporting event in progress without lagging or delay in the play by play.

### BRIEF SUMMARY

There is provided a method of broadcasting a live performance. A back end gateway is provided that has setup functions for a broadcaster to set up a broadcast. A live broadcasting signal is sent to the back end gateway. A front end gateway is provided that allows a user to connect to the live broadcast. The live broadcasting signal is sent from the back end gateway to the front end gateway. A user is provided with access to the front end gateway to allow them to access the live broadcast.

In one embodiment, the live broadcasting signal is encrypted to prevent unauthorized connection from the front end gateway.

In one embodiment, the broadcaster can notify the user of the front end gateway that the live broadcasting signal is being provided to the front end gateway within a predetermined play radius.

In one embodiment, the back end gateway provides the broadcaster with audio control settings for the live broadcasting signal. These audio control setting may allow for the customization of treble, midrange, bass and balance. A mixer may also be provided to allow for ambient sounds to be mixed in with the live broadcast.

In one embodiment, the front end gateway provides the user with audio control settings for the playback of the live broadcasting signal. These audio settings may allow for the alteration of balance, treble, midrange and base to improve individual experience.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a flow chart of the method of broadcasting a live performance.

### DETAILED DESCRIPTION OF THE PREFERRED EMBODIMENTS

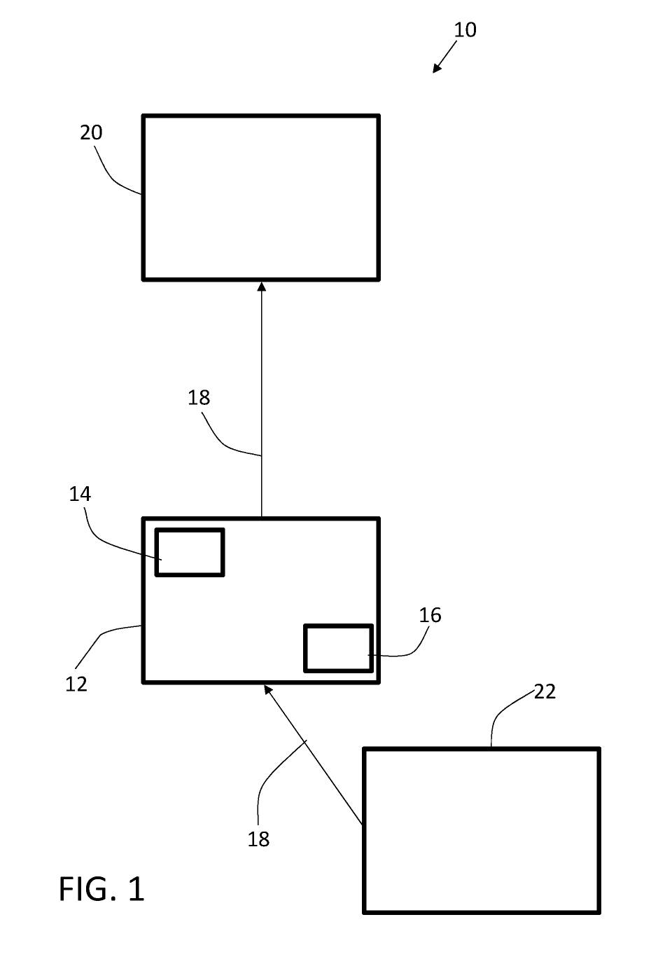

A method of broadcasting a live performance, generally identified by reference numeral 10, will now be described with reference to FIG. 1.

The method of broadcasting a live performance is adapted to allow a user to hear a live broadcasting performance, such as the play by play by commentators at a sporting event, where the user is in attendance at the event or within a predetermined play radius. The method allows for minimal delay in broadcasting in what is being heard to what is being watched live. This allows the user to access the play by play and adjust the volume according to the preference of the user and the noise in the arena.

A back end gateway 12 is provided that allows a broadcaster to set up a broadcast. Back end gateway 12 provides access to setup and management of the live broadcast. Setup 14 may include the option to customize audio settings such as treble, midrange, base and balance. A mixer 16 may be provided to allow for ambient sounds to be mixed in with the live broadcasting signal 18. Ambient sounds may include sounds from the audience or, where a sporting event is being broadcast, sounds from the playing field. A broadcaster may also enable a setting that provides a signal to all potential users within a predetermined area that access to the live event may be available. The predetermined area may be determined by a WIFI signal range within a building or venue or may be determined based upon the location of the potential user.

Broadcaster may test the settings to check audio quality and response time for the live broadcast. Filters may be provided to filter out unwanted noise and balance, treble, midrange and base can be adjusted to balance the audio and ambient sounds to the broadcaster's liking.

Back end gateway 12 may provide statistical information related to the live broadcast such as how many people have listened to the live broadcast, how many people are currently listening to the live broadcast and other information that the broadcaster may be interested in having.

A front end gateway 20 is provided that allows users access to the live broadcasting signal 18. The live broadcasting signal 18 is sent from the back end gateway 12 to the front end gateway 20. When a user enters the predetermined area, such as a WIFI zone, a prompt may be provided that tells the user that a live broadcast will occur. The prompt comes as a result of the signal being enabled by the broadcaster to provide a signal to all potential users within the predetermined area. A user will also have the option to search from the front end gateway 20 to determine what, if any, live broadcasts are being provided in the area in which the user is. User may be able to adjust settings such as balance, treble, midrange and base, as well as filter out ambient sounds from spectators and the field of play. There may also be the option to listen to specific broadcasters when more than one broadcaster is providing a live broadcast within the predetermined area. During intermissions a user may be able to listen to local intermission shows, player interviews or other available broadcasts. Preference as to what plays during intermissions can be customized by the user.

Access to front end gateway 20 may require authentication by a user or prepayment for access to live broadcasting. Front end gateway 20 may have setup features such as audio settings that alter balance, treble, midrange and base to improve individual experience. Live broadcasting signal 18 may be encrypted to prevent unauthorized connection from the front end gateway 20 and pirating of the live broadcasting signal 18. Front end gateway 20 may also provide information related to sports updates and interviews. Front end gateway 20 may also allow a user to set up a profile and save custom settings for the user.

A broadcaster's audio can be sent as a live broadcasting signal 18 directly from sound equipment 22, such as microphones and sound boards, as they give their performance. The sound equipment 22 may be wired or wirelessly connected to back end gateway 12. Live broadcasting signal 18 is then filtered and balanced based upon the settings originally set by the broadcaster. The broadcaster will have the ability to enable or disable the sending of the live broadcasting signal from the back end gateway 12 to the front end gateway 20. The live broadcasting signal 18 is sent from back end gateway 12 to the front end gateway 20 over a WIFI signal to those people in attendance who have access to the front end gateway 20.

Back end gateway 12 and front end gateway 20 may be a part of a software that is accessible through cellular phones, computers or other electronic devices.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A method of broadcasting a live performance, comprising:
providing a back end gateway, the back end gateway having a setup function for a broadcaster to set up a live broadcast;
sending a live broadcasting signal to the back end gateway;
providing a front end gateway, the front end gateway allowing a user to connect to the live broadcast;
sending the live broadcasting signal from the back end gateway to the front end gateway; and
providing to a user access to the front end gateway.

2. The method of claim 1 wherein the live broadcasting signal is encrypted to prevent unauthorized connection from the front end gateway.

3. The method of claim 1 wherein the broadcaster can notify the user of the front end gateway of the live broadcasting signal being provided to the front end gateway within a predetermined play radius.

4. The method of claim 1 wherein the back end gateway provides the broadcaster with audio control settings for the live broadcasting signal.

5. The method of claim 1 wherein the front end gateway provides the user with audio control settings for the playback of the live broadcasting signal.
